(19) United States
(12) Patent Application Publication
(10) Pub. No.: US 2023/0287977 A1
(43) Pub. Date: Sep. 14, 2023

(54) SEAL PART

(71) Applicant: InnoME GmbH, Espelkamp (DE)

(72) Inventor: Eike Wilhelm Kottkamp, Lübbecke (DE)

(73) Assignee: InnoME GmbH, Espelkamp (DE)

(21) Appl. No.: 18/040,478

(22) PCT Filed: Jul. 21, 2021
(86) PCT No.: PCT/EP2021/070444

§ 371 Date: Feb. 3, 2023

(30) Foreign Application Priority Data
Aug. 5, 2020 (DE) 10 2020 120 682.8

(51) Int. Cl. F16J 15/06

(52) U.S. Cl. CPC F16J 15/064

(57) ABSTRACT

A sealing part with a sealing element, in particular a preferably annular flat seal which has at least one sealing element surface for bearing against a sealing surface and for sealing the latter, in which the sealing part has a foil sensor unit with at least one sensor element for monitoring the functionality of the sealing element, wherein the foil sensor unit is arranged completely or partially on an outer side of the sealing element, in particular on the sealing element surface, in particular is fastened undetachably or detachably to the outer side, or wherein the foil sensor unit is integrated completely or partially into the sealing element.

### CROSS REFERENCE TO RELATED APPLICATIONS

This application is the US national phase of and claims the benefit of and priority on International Application No. PCT/EP2021/070444 having an international filing date of 21 Jul. 2021, which claims priority on and the benefit of German Patent Application No. 10 2020 120 682.8 having a filing date of 5 Aug. 2020.

### BACKGROUND OF THE INVENTION

### Technical Field

The present invention relates to a sealing part with a sealing element, in particular a preferably annular flat seal or a flat seal with a contour geometry which has at least one sealing element surface for bearing against a sealing surface of a component and for sealing the latter.

### Prior Art

Sealing elements are widely used in the prior art in many different forms and manifestations, for example in order to seal connecting or sealing surfaces, such as for example the corresponding surfaces of connecting flanges, of a very wide range of liquid or gas lines which are to be connected to one another, mediatightly relative to one another. The same applies to the sealing of vessels of any type for holding liquids or gas relative to stoppers, lids, etc., for these vessels.

Sealing elements are generally parts which are subject to wear and which can become defective, inter alia, by mechanical and chemical stresses or ageing effects. As is known, defective sealing elements can cause significant consequential damage, in particular when the defectiveness is identified only late.

It has occasionally been known in the prior art to associate sensors, for example power sensors, with sealing elements in order to identify damage, cf EP 2 801 739 A2.

The solutions of the prior art either require a lot of effort and are cost-intensive or change the standard dimensions of the sealing element disadvantageously.

### BRIEF SUMMARY OF THE INVENTION

Against this background, an object of the present invention is to provide a sealing part with a sealing element of the type mentioned at the beginning, in which imminent defectiveness or defectiveness which has already occurred can be identified at an early stage without (a need for) the (standard) dimensions of the sealing element necessarily being changed in a particular way or without the sealing effect of the sealing element being significantly reduced.

This object is achieved by a sealing part with a sealing element, in particular a preferably annular flat seal or a flat seal with a contour geometry which has at least one sealing element surface for bearing against a sealing surface and for sealing the latter, characterized in that the sealing part has a foil sensor unit with at least one sensor element for monitoring the functionality of the sealing element, wherein the foil sensor unit is arranged completely or partially on an outer side of the sealing element, in particular on the sealing element surface, in particular is fastened undetachably or detachably to the outer side, or wherein the foil sensor unit is integrated completely or partially into the sealing element.

A sealing part according to the invention of the type mentioned at the beginning is characterized in that the sealing part has a foil sensor unit with at least one sensor element for monitoring the functionality of the sealing element, wherein the foil sensor unit is arranged either completely or partially (detachably or preferably undetachably) on an outer side of the sealing element, in particular on the sealing element surface which bears against the respective sealing surface of each component which is to be sealed, or wherein the foil sensor unit is integrated completely or partially into the sealing element.

This arrangement of a foil sensor unit, which is of an extremely thin and flexible type, on the outer side of the sealing element, or this integration of such a unit into the sealing element, makes it possible, on the one hand, to identify at an early stage already existing damage of the sealing element, or damage which is being caused, by the sensor element of the foil sensor detecting one or more suitable parameters of the sealing element which can indicate such damage, and, on the other hand, the (standard) dimensions or measurements of which can remain unchanged or virtually unchanged.

The foil sensor unit can expediently have at least one flexible, preferably stretchable piece of foil which has at least one electrical line or trace, preferably at least two electrical lines/traces, to which the sensor element is in turn (indirectly or directly) electrically connected.

The sensor element is here preferably also arranged on or in the flexible piece of foil or is a constituent part thereof. In particular, it is arranged on or in the flexible piece of foil in a region of the latter in which the flexible piece of foil bears against the sealing element surface.

It is, however, in principle also conceivable that the sensor element is not arranged on or in the flexible piece of foil and instead is connected to the piece of foil only indirectly via one or more electrical lines and/or electrical contact terminals of the piece of foil.

In terms of the flexible piece of foil, it can have precisely one layer of a flexible foil material or multiple layers, one arranged above the other, each of a flexible foil material. One layer, multiple layers, or each layer can here be formed from a plastic foil material, in particular from EPDM.

The flexible piece of foil can preferably be fastened detachably or undetachably on the sealing element surface of the sealing element and completely or partially cover this sealing element surface in a covering region, preferably bearing against the sealing element surface.

In terms of the (outer) contour determined by the (outer) edge/edges, and/or the shape of the piece of foil, it can be adapted to the contour and/or shape of the sealing element, in particular to the contour and/or shape of the sealing element surface, in one region, preferably in the covering region. In particular, it can essentially match the contour and/or shape of the sealing element.

The sealing element surface can, for example, have an annular or circular or polygonal design or have a (different) contour geometry. The piece of foil can then be fastened to this sealing element surface, thus completely or partially cover the latter, and additionally, like the sealing element surface situated underneath, have an annular or circular or polygonal design or have the contour geometry in the covering region.

It can further be provided that the piece of foil has two separate foil piece arms, each with a free end, in one region, in particular in the covering region.

The sealing element surface can here have, for example, an annular design, wherein each foil piece arm is associated with a partially annular section of the sealing element surface and completely or partially covers the latter.

According to a further embodiment of the invention, the foil sensor unit can have an in particular strip-like contact tongue, preferably comprising the at least one electrical line or trace and in particular connected preferably integrally to the piece of foil, via which the foil sensor unit can be contacted electrically.

The contact tongue can preferably lead out of the region of the sealing element preferably at least in one section and can protrude at least partially in particular laterally beyond the latter, preferably along a section with a length of at least 0.5 cm.

The sealing element can furthermore have a second sealing element surface, which is in particular situated opposite the first sealing element surface and is preferably arranged in a parallel plane, for bearing against one or the sealing surface of a component to be sealed and for sealing the sealing surface, and wherein in each case a foil sensor unit bears against and/or is fastened to the two sealing body surfaces. Two foil sensor units can here correspondingly be designed as described above or below and have one or more of the described features.

According to the abovementioned alternative embodiment, it can furthermore also be provided that the foil sensor unit, apart from at least partial regions of the contact tongue and/or the at least one line or trace and/or the sensor element, is embedded on all sides in the sealing element, namely is surrounded by the material of the sealing element.

In terms of the sensor element of the foil sensor, the foil sensor unit for monitoring the functionality of the sealing element can comprise an in particular capacitive or piezoresistive pressure sensor element and/or a temperature sensor element.

The foil sensor unit can here have, for example, multiple pressure sensor elements for measuring local compressive stress of the sealing element.

According to a further embodiment of the invention, the foil sensor unit can have a further sensor element for measuring at least one parameter of a liquid or gaseous medium with which the sensor element can be brought into contact. This occurs in particular when the sealing part is used for sealing a hollow body through the interior of which the medium can pass or in the interior of which the medium can be arranged.

This can preferably be, for example, a sensor element for measuring the pH value, the temperature, the pressure, and/or the flow rate of a liquid or gaseous medium.

The further sensor element can here be arranged on or in a tab of foil material which extends away from the sealing element, is connected in particular integrally to the flexible piece of foil, and is preferably formed from the latter.

It can, for example, also be provided that the sealing element is designed as a (closed) sealing element ring, wherein the further sensor element is arranged radially further inward relative to the sealing element ring and in the region of the sealing element ring interior which is enclosed or surrounded by the sealing element ring.

The further sensor element can here be arranged on or in a tab of foil material which is connected to the flexible piece of foil, is preferably formed from the latter, and extends from the sealing element ring as far as the region of the sealing element ring interior.

### BRIEF DESCRIPTION OF THE DRAWINGS

Further features of the present invention can be found in the attached patent claims, the following description of preferred exemplary embodiments, and the attached drawings, in which:

FIG. 1 shows an oblique view of a first embodiment of a sealing element according to the invention with a foil sensor unit, arranged on a sealing element surface, with a sensor element for monitoring the functionality of the sealing element,

FIG. 2 shows the sealing element according to FIG. 1 in partial section,

FIG. 3 shows an alternative embodiment of a sealing element according to the invention with foil sensor units arranged at two sealing element surfaces situated opposite each other,

FIG. 4 shows the sealing element according to FIG. 3 in partial section,

FIG. 5 shows a further embodiment of a sealing element according to the invention in an oblique view with a foil sensor unit integrated into the sealing body,

FIG. 6 shows the sealing element according to FIG. 5 in partial section,

FIG. 7 shows a further embodiment of a sealing element according to the invention in an oblique view in which the foil sensor unit has an open contour or shape,

FIG. 8 shows a further embodiment of a sealing element according to the invention in which the foil sensor unit has an additional tab on which a further sensor element is arranged for detecting parameters of a liquid or gaseous medium.

### DETAILED DESCRIPTION OF PREFERRED EMBODIMENTS

The embodiments depicted in the drawings of a sealing part 10 according to the invention each have an annular sealing element 11 with in this case (circular) annular lateral surfaces 12a and 12b which are arranged in parallel planes. The lateral surfaces 12a and 12b are the sealing element surfaces of the sealing element 11 which bear against respective sealing surfaces of one or more components to be sealed when the sealing part 10 or the sealing element 11 is used, for example against sealing surfaces of connecting flanges of tubes or the like.

In the present case, the annular sealing element 11 is a so-called flat seal. However, the invention is not limited to such flat seals as sealing elements. Thus, a wide range of different shapes and types of sealing element can also be used.

The invention is also not limited to specific materials from which the sealing elements are produced. Thus, for example, different plastic materials such as EDPM, PTFE, or other materials can be used, inter alia.

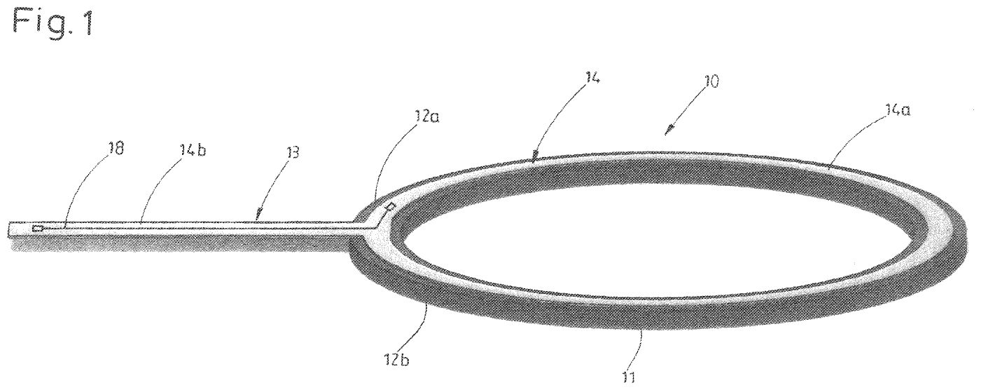

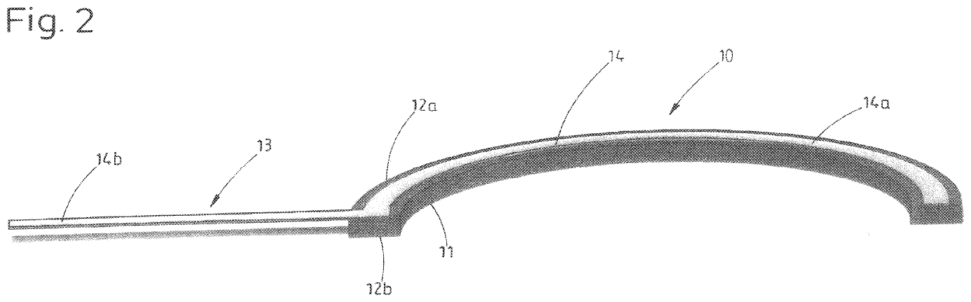

In the present case, the sealing part 10 shown in FIGS. 1 and 2 has a foil sensor unit 13 for monitoring the functionality of the sealing element 11.

The basic structure of such foil sensors and foil sensor units are known from the prior art.

In the present case, the foil sensor unit 13 comprises a flexible piece of foil 14 which has a sensor element 19 for monitoring the functionality of the sealing element 11.

The flexible piece of foil 14 of the foil sensor unit 13 comprises one or more layers of flexible foil. The sensor element 19 here generally sits on one or the foil layer or is fastened there. It can be covered by one or more further foil layers but this does not have to be the case.

In the same way, electrical lines or traces are generally arranged, for example imprinted, on the or a foil layer of the piece of foil 14. Such a trace 18, which is routed to the sensor element 19, is shown by way of example in FIG. 1.

In the present case of the embodiment in FIG. 1, the piece of foil 14 has two regions, namely a first annular region 14a and a second strip-like region or section 14b.

The shape and contour of the annular region 14a is adapted to the annular sealing element 11, in the present case in such a way that the annular region 14a fits directly onto the annular sealing element surface 12a without protruding laterally therefrom.

The annular region 14a of the piece of foil 14 is in the present case connected permanently and undetachably to the sealing element surface 12 or fastened thereto. The annular region 14a of the piece of foil 14 could be adhesively bonded, for example, to the sealing element surface 12a arranged underneath it.

The annular region 14a of the piece of foil 14 here covers the annular sealing element surface 12a over the whole circumference or on two (narrow) edge strips.

The strip-like region 14b of the flexible piece of foil 14 forms a contact tongue or contact lug for contacting the monitoring sensor element 19 associated with the annular region 14a of the piece of foil 14. For this purpose, the at least one trace 18 is routed outward from the sensor element 19 along the strip-like region 14b, i.e. into a region outside the sealing element 11.

The small structure and the small height of the flexible piece of foil 14, in particular of the annular region 14a, makes it possible for the sealing part 10 to bear, for the purpose of sealing, against the sealing surfaces of one or more of the separate components which are not shown and to seal the latter and thus to simultaneously monitor the functionality of the sealing element 11 over the lifetime of the sealing element 11. This takes place, however, without significantly changing the properties, the sealing effect, and the structural height of the sealing element 11.

The foil sensor unit 13 can here be connected electrically via the contact tongue and the strip-like region 14b to a separate evaluation and monitoring unit which evaluates the corresponding signals of the sensor element 19 and checks whether the sealing element 11 is defective. For example, the sensor element 19 could be a pressure sensor which, in its installed situation, determines whether the pressure acting on the sealing element 11 or the counterpressure exerted thereby changes over the course of the time during which the sealing element 11 is used.

It is, however, alternatively also conceivable that the signals of the sensor element 19 are transmitted wirelessly to the separate evaluation and monitoring unit. The at least one trace 18 or generally at least two traces 19 would then serve especially to supply power to the sensor element 19. A wide range of different configurations are conceivable which are known to a person skilled in the art.

Furthermore, various types of sensor elements, which can measure a wide range of different parameters, can be used to monitor the functionality of the sealing element 11. The crucial point is that these sensor elements and parameters are ones which allow conclusions to be reached about the functionality of the sealing element 11. Thus, the temperature which exists at the location of the sealing element 11 could, for example, be such a parameter in addition to the pressure.

In the embodiment in FIG. 1, the contact tongue or the strip-like region 14b is furthermore (integrally) formed directly from the flexible piece of foil 14. However, this does not have to be the case.

In the example in FIG. 1, the sensor element 19 is furthermore associated directly with the piece of foil 14 and in particular the annular region 14a by it being arranged/fastened in or on the piece of foil 14 which can be designed with one or multiple layers. It is, however, also conceivable to use a separate sensor element which is electrically contacted via corresponding contact points of the piece of foil 14b and on the piece of foil 14.

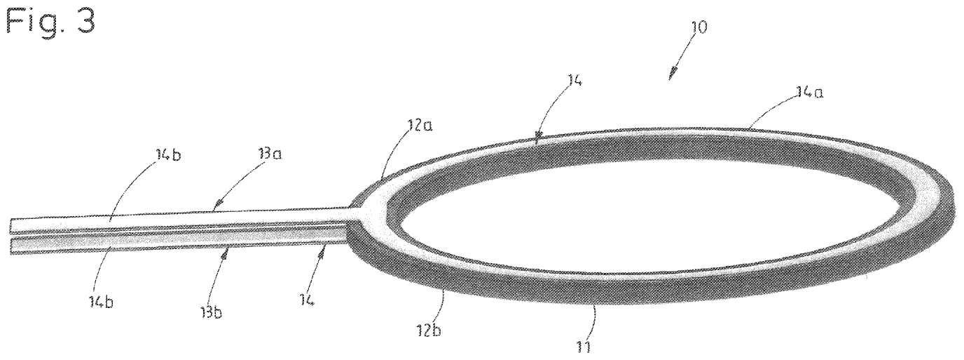

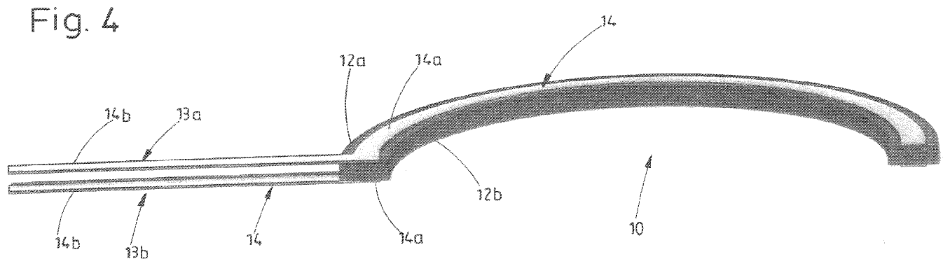

The embodiments in FIGS. 3 and 4 differ from the embodiment in FIGS. 1 and 2 in that the sealing part 10 has not just one but two foil sensor units 13, namely a first foil sensor unit 13a which is associated with the sealing element surface 12a, and a second foil sensor unit 13 which is associated with the sealing element surface 12b. Accordingly, the annular region 14a of the flexible piece of foil 14 of one foil sensor unit 13a is arranged on the sealing element surface 12a and is fixedly connected to the latter, and the annular region 14a of the flexible piece of foil 14 of the other foil sensor unit 13b on the sealing element surface 12b.

Each foil sensor unit 13 here accordingly has its own contact tongue which leads to the outside and a strip-like region 14b.

Note: for the sake of simplicity, the exemplary sensor element 19 and the exemplary trace 18 leading to the latter have been omitted in FIGS. 2-8.

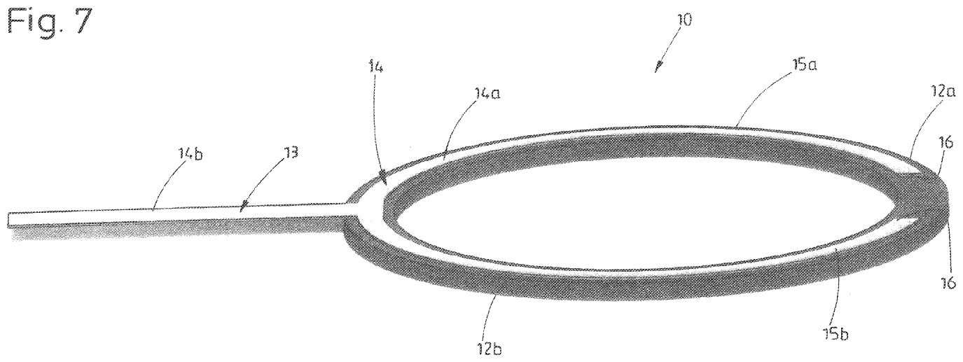

The embodiment in FIG. 7 differs from the embodiment in FIGS. 1 and 2 inasmuch as the region 14a of the flexible piece of foil 14 does not represent a closed ring but rather an open ring with in each case two foil piece arms 15a and 15b, each with a free end 16. This open shape or open contour of the piece of foil 14 makes it possible for the foil sensor unit 13 to be removed from the sealing element 11 even when it is situated in an installed situation, at least in the case where a detachable connection is provided between the foil piece arms 15a, 15b and the sealing element surface 12a.

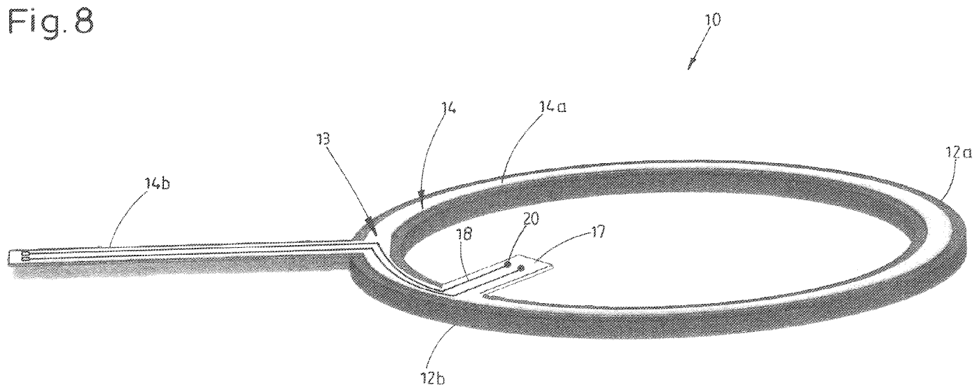

The embodiment in FIG. 8 differs from the embodiments 1 and 2 in that the flexible piece of foil 14 has a tab 17 which is directed inward in this case and is integrally connected in the present case to the annular region 14a, i.e. is part of the piece of foil 14. However, this does not have to be the case.

At least one further sensor element 20 (two sensor elements 20 are shown in the present example), by means of which, for example, one or more parameters of a liquid or gaseous medium which flows through the interior surrounded by the sealing element 11 or is situated there can be measured, can be arranged on the tab 17. For example, the sealing element 11 could be arranged between two connecting flanges of two pipelines which are connected to each other in the flange region. Medium flowing through the pipelines would then wash or flow around the respective sensor element 20 arranged on the tab. The pH value, the temperature, the pressure, and/or the flow rate of a or the liquid or gaseous medium would, inter alia, come into question as parameters to be measured.

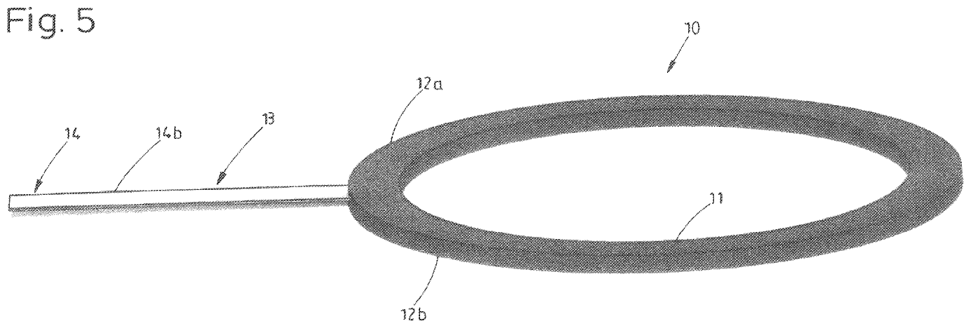

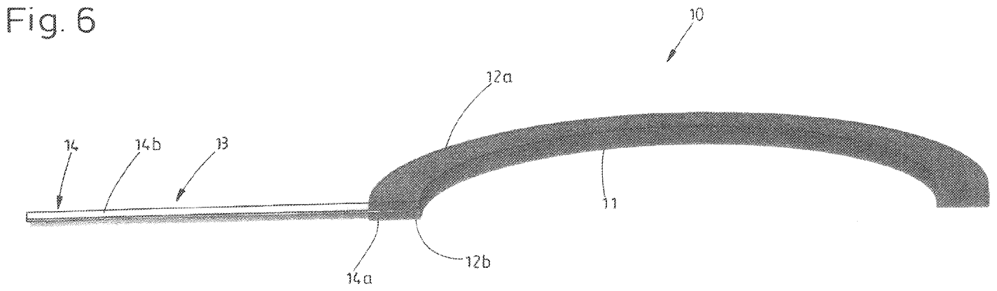

The embodiments in FIGS. 5 and 6 differ from the embodiment in FIGS. 1 and 2 in that the flexible piece of foil 14 of the foil sensor unit 13 is not arranged or fastened on the outside of the sealing element surface 12a (or 12b) and instead is integrated into the sealing element 11, namely is surrounded on all aides by the material of the sealing element 11 or is embedded into it, and to be precise in the present case except for a section/region of the strip-like region 14b which leads from the material to the outside. In this case, the foil sensor unit 13 would be introduced into the sealing element 11 while it is being produced, whilst in the other embodiment shown subsequent fastening of the foil sensor unit 13 to the annular sealing element 11 is also conceivable.

### LIST OF REFERENCE SIGNS

10 sealing part
11 annular sealing element
12a sealing element surface
12b sealing element surface
13 foil sensor unit
13a foil sensor unit
13b foil sensor unit
14 flexible piece of foil
14a annular region
14b strip-like region
15a foil piece arm
15b foil piece arm
16 free end
17 tab
18 trace
19 sensor element for monitoring the sealing element
20 sensor element for monitoring a medium

1. A sealing part with a sealing element (11), namely an annular flat seal or a flat seal with a contour geometry which has at least one sealing element surface (12a, 12b) for bearing against a sealing surface and for sealing the sealing surface, wherein the sealing part has a foil sensor unit (13, 13a, 13b) with at least one sensor element (19) for monitoring the functionality of the sealing element (11), wherein the foil sensor unit (13) is arranged completely or partially on an outer side of the sealing element (11), namely on the sealing element surface (12a, 12b), wherein the foil sensor unit (13) is fastened undetachably or detachably to the outer side, or wherein the foil sensor unit (13, 13a, 13b) is integrated completely or partially into the sealing element (11).

2. The sealing part as claimed in claim 1, wherein the foil sensor unit (13, 13a, 13b) has at least one flexible, preferably stretchable piece of foil (14), with one or more material layers of foil, which has at least one electrical line or trace to which the sensor element (19) is electrically connected.

3. The sealing part as claimed in claim 2, wherein the sensor element (19) is arranged on or in a flexible piece of foil (14), in a region in which the flexible piece of foil (14) bears against the sealing element surface (12a, 12b).

4. The sealing part as claimed in claim 3, wherein the flexible piece of foil (14) is fastened detachably or undetachably on the sealing element surface (12a, 12b) and completely or partially covers the latter in a covering region, preferably bearing against the sealing element surface (12a, 12b).

5. The sealing part as claimed in claim 3, wherein the has a flexible piece of foil (14) contour and/or shape that is adapted to a contour and/or shape of the sealing element (11), in one region, preferably in the covering region, namely to the contour and/or shape of the sealing element surface (12a, 12b).

6. The sealing part as claimed in claim 5, wherein the sealing element (11) or the sealing element surface (121, 12b) have an annular or circular or polygonal design or have a contour geometry, and wherein the flexible piece of foil (14) likewise has an annular or circular or polygonal design or has a or the contour geometry in one region, preferably in the covering region.

7. The sealing part as claimed in claim 3, wherein the flexible piece of foil (14) has two separate foil piece arms (15a, 15b), each with a free end (16) and preferably connected in a detachable manner to the sealing element surface (12a, 12b) in the covering region.

8. The sealing part as claimed in claim 7, wherein the sealing element surface (12a, 12b) has an annular design, wherein each foil piece arm (15a, 15b) is associated with a partially annular section of the sealing element surface (12a, 12b) and completely or partially covers the latter.

9. The sealing part as claimed in claim 1, wherein the foil sensor unit (13, 13a, 13b) has a strip-like contact tongue or contact lug, preferably comprising the at least one electrical line or trace and connected preferably integrally to the flexible piece of foil (14), via which the foil sensor unit (13, 13a, 13b) can be contacted electrically.

10. The sealing part as claimed in claim 9, wherein the contact tongue or contact lug protrudes at least partially in particular laterally beyond the sealing element (11), preferably along a section with a length of at least 0.5 cm.

11. The sealing part as claimed in claim 1, wherein the sealing element (11) has a second sealing element surface (12b), which is in particular situated opposite the first sealing element surface (12a) and is preferably arranged in a parallel plane, for bearing against one or the sealing surface for sealing the latter, and wherein in each case a foil sensor unit (13a, 13b), in particular in each case a flexible piece of foil (14) of each foil sensor unit (13a, 13b), bears against and/or is fastened to the two sealing element surfaces (12a, 12b).

12. The sealing part as claimed in claim 9, wherein the foil sensor unit (13, 13a, 13b), apart from at least partial regions of the contact tongue/contact lug and/or the at least one electrical line or trace and/or the sensor element (19), is embedded on all sides in the sealing element (11), namely is surrounded by the material of the sealing element (11).

13. The sealing part as claimed in claim 1, wherein the foil sensor unit (13, 13a, 13b) for monitoring the functionality of the sealing element (11) comprises an in particular capacitive or piezoresistive pressure sensor element and/or a temperature sensor element.

14. The sealing part as claimed in claim 13, wherein the foil sensor unit (13, 13a, 3b) has multiple pressure sensor elements for measuring local compressive stress.

15. The sealing part as claimed in claim 1, wherein the foil sensor unit (13, 13a, 13b) has at least one further sensor element (20) for measuring at least one parameter of a liquid or gaseous medium with which the at least one further sensor element (20) can be brought into contact, in particular when the sealing part is used for sealing a hollow body through the interior of which the medium can pass or in the interior of which the medium can be arranged, preferably at least one further sensor element (20) for measuring the pH value, the temperature, the pressure, and/or the flow rate of a liquid or gaseous medium.

16. The sealing part as claimed in claim 15, the foil sensor unit (13, 13a, 13b) has at least one flexible piece of foil (14), wherein wherein the at least one further sensor element (20) is arranged on or in a tab of foil material which extends away from the sealing element (11) and is connected in particular integrally to the flexible piece of foil (14).

17. The sealing part as claimed in claim 15, wherein the sealing element (11) is designed as a closed sealing element ring, wherein the at least one further sensor element (20) is arranged radially further inward relative to the sealing element ring and in the region of the sealing element ring interior which is enclosed or surrounded by the sealing element ring.

18. The sealing part as claimed in claim 17, wherein the foil sensor unit (13, 13a, 13b) has at least one flexible piece of foil (14), wherein the at least one further sensor element (20) is arranged on or in a tab of foil material which is connected to the flexible piece of foil (14), is preferably formed from the flexible piece of foil (14), and extends from the sealing element ring radially further inward and into the region of the sealing element ring interior.

19. The sealing part as claimed in claim 3, wherein one or more or each foil layer of the flexible piece of foil (14) is/are formed from plastic, in particular from EPDM.

20. A foil sensor unit for a sealing part, is fastened undetachably or detachably to the outer side, or wherein the foil sensor unit (13, 13a, 13b) is integrated completely or partially into the sealing element (11), wherein the foil sensor unit (13) on the sealing element surface (12a, 12b), namely the sealing part has a foil sensor unit (13, 13a, 13b) with at least one sensor element (19) for monitoring the functionality of the sealing element (11), wherein the foil sensor unit (13) is arranged completely or partially on an outer side of the sealing element (11), wherein, sealing surface sealing element surface (12a, 12b) for bearing against a sealing surface and for sealing the one annular flat seal or a flat seal with a contour geometry which has at least namely an a sealing element (11), having sealing part the.

21. (canceled)
